(19) United States
(12) Patent Application Publication
(10) Pub. No.: US 2020/0094299 A1
(43) Pub. Date: Mar. 26, 2020

(54) Cleaning, recycling and compression device for plastic beverage bottles

(71) Applicant: Yongjun Shu, Foshan City (CN)

(72) Inventor: Yongjun Shu, Foshan City (CN)

(21) Appl. No.: 16/697,193

(22) Filed: Nov. 27, 2019

(30) Foreign Application Priority Data
Aug. 9, 2019 (CN) 2019107335278

(51) Int. Cl. B08B 9/30; B08B 3/04; B08B 9/20; B08B 9/36; B08B 9/42; B29B 17/00

(52) U.S. Cl. CPC B08B 9/30; B08B 3/041; B08B 9/205; B29B 2017/0057; B08B 9/426; B29B 17/0052; B08B 9/36

(57) ABSTRACT

The invention discloses a device for cleaning, recycling, and compressing a plastic beverage bottle, which includes a body. The body is provided with a working cavity. The working cavity is provided with a moving conveyor belt. The conveyor belt is provided with a fixed cavity. The cavity is provided with a fixing device for fixing the water bottle. The motor is first moved away, and the plastic bottles are fixed between the fixing blocks, and then water is injected into the water injection port. The device can wash and clean the plastic bottles after drinking, thus completing the automatic preliminary treatment of plastic bottles. Compared with traditional processing methods, the device does not require manual processing of plastic bottles, saving manpower and material resources. At the same time, the device cleans plastic bottles, which can ensure that during subsequent reprocessing, there can be health protection.

### CROSS-REFERENCES TO RELATED APPLICATIONS

The present application claims priority from Chinese application No. 2019107335278 filed on Aug. 9, 2019 which is hereby incorporated by reference in its entirety.

### TECHNICAL FIELD

The invention relates to the field of garbage, in particular to a cleaning, recycling and compression device for plastic beverage bottles.

### BACKGROUND OF THE INVENTION

With the progress of the society, people have paid more and more attention to environmental protection. After the plastic beverage bottles are used up, they need to be initially recycled to the plastic recycling yard. The existing preliminary recycling methods are all by sanitation workers. Pour the water out of the plastic bottle and then compress it manually. This method is not sufficiently compressed, and the bottle has not been cleaned, and it is directly compressed, which is not conducive to subsequent processing, and it also easily affects the environment of the reprocessing plant.

### BRIEF SUMMARY OF THE INVENTION

The purpose of the present invention is to provide a cleaning, recycling and compression device for plastic beverage bottles, so as to solve the problems raised in the background art mentioned above.

In order to achieve the above objective, the present invention provides the following technical solution: A plastic beverage bottle washing, recycling, and compression device includes a body, the body is provided with a working cavity, and the working cavity is provided with a moving conveyor belt. A fixing cavity is provided, and a fixing device for fixing a water bottle is provided in the fixing cavity;

The fixing device includes a top chute symmetrically disposed on a side wall of the fixing cavity, and a top rod is slidably connected in the top chute, and a small spring is connected between the top rod and the top chute. A trapezoidal block is fixed on the top side of the ejector rod, and a fixing block for gripping the bottle mouth is fixed on one side of the ejector rod. The fixing block can be fixedly connected with a plastic bottle, and the bottom surface of the conveyor belt is fixedly provided. A trigger lever, a bottom wall of the working chamber is provided with a cleaning chamber with an opening downward, a bottom side of the cleaning chamber is provided with a water tank, and a water outlet pipe is connected between the water tank and the cleaning chamber;

A water spraying device for cleaning plastic bottles is provided between the water tank and the cleaning cavity, a power cavity is provided on the bottom wall of the working cavity, and a brush head device is provided in the power cavity to assist in cleaning the plastic bottles. An opening cavity is provided on the top wall of the working cavity, and an extrusion cavity is provided on the top side of the opening cavity. An extrusion device for squeezing a plastic bottle is provided in the extrusion cavity, and a bottom of the working cavity is provided. The wall is provided with a drop cavity, and the rear side of the working cavity is provided with a transmission device for transmitting power to the pressing device.

On the basis of the above technical solution, the water spraying device includes a drainage pipe provided on the right wall of the cleaning chamber, and the bottom wall of the working chamber is symmetrically provided with a wedge chute with downward openings, and the wedge chute A rack wedge block that can abut the trigger rod is slidably connected in the middle, and a right side wall of the wedge block chute on the right side is provided with a through cavity that communicates with the cleaning cavity. A rotating shaft is rotatably connected to the side wall, a rotating gear meshing with the rack wedge is fixed on the rotating shaft, a switching cavity is provided on the bottom wall of the cleaning chamber, and a right angle is engaged on the right side of the rotating gear A rack, a nozzle is fixed on the top surface of the angled rack, a telescopic hose is fixed on the bottom side of the angled rack, and the bottom side of the telescopic hose is in communication with the water outlet pipe, The bottom wall is fixedly provided with a water pump connected to the water outlet pipe, a rear side wall of the water tank is provided with a water injection port opening backward, a bottom surface of the angled rack is hinged with a hinge rod, and a bottom wall of the switching cavity A horizontal plate chute penetrating the outlet pipe is provided, and the bottom side of the hinge rod is hinged with the horizontal plate. Sliding chute connected to the horizontal plate, said horizontal plate may be provided with the delivery tube communicating with the through hole, the sidewall of the cavity after the switching port is provided for addition of cleaning agent is added.

On the basis of the above technical solution, the brush head device includes a motor fixedly installed on the bottom wall of the power chamber, and a motor shaft is dynamically connected to the motor, and a power gear is fixed on the top side of the motor shaft. A first bevel gear is fixed on the middle side of the motor shaft, a penetrating shaft is rotatably connected to the rear side wall of the power cavity, and a second cone is fixed on the front side of the penetrating shaft and can be engaged with the first bevel gear. Gear, the bottom side of the power chamber is provided with a hydraulic chute, the left side wall of the hydraulic chute is provided with an oil pipe, the top wall of the oil pipe is provided with a fuel tank, and the bottom surface of the rack wedge on the left side slides A long rod slidingly connected to the bottom wall of the wedge chute on the left side is connected, and the long rod extends downwardly through the bottom wall of the wedge chute and enters the fuel tank, and is connected to the fuel tank. The top wall is slidingly connected, a pressure plate slidingly connected to the fuel tank is fixed on the bottom side of the long rod, a limiting block is fixedly located on the right side of the hydraulic chute, and hydraulic pressure is slidingly connected to the hydraulic chute. A slide block is provided with hydraulic oil between the hydraulic slide block and the pressure plate. A vertical shaft is rotatably connected to the top side of the hydraulic shaft, and the vertical shaft is slidingly connected to the top wall of the hydraulic chute. The top side of the vertical shaft extends upward through the top wall of the hydraulic chute and enters the power chamber. And is slidably connected to the bottom wall of the power chamber, a moving gear that can mesh with the power gear is fixed on the middle side of the vertical shaft, and a top side of the vertical shaft is fixed on the top side of the vertical shaft for cleaning the inner wall of the plastic bottle Soft bristle brush.

On the basis of the above technical solution, the extrusion device includes a horizontal axis that is rotatably installed on the right wall of the extrusion cavity, a third bevel gear is fixed on the middle side of the horizontal axis, and the left side of the horizontal axis A cam is fixed, and an extension shaft is rotatably connected to the rear side wall of the extrusion cavity. A fourth bevel gear meshing with the third bevel gear is fixed on the front side of the extension shaft. A push plate is slidably connected, and a strong spring is connected between the push plate and the bottom. A thin rod is fixed on the bottom side of the push plate, and the thin rod extends downward through the bottom wall of the extrusion cavity to enter. Into the opening cavity and slidingly connected with the bottom wall of the pressing cavity and the top wall of the opening cavity, and a bottom of the thin rod is fixedly provided with an extruding plate that can abut the trapezoidal block.

On the basis of the above technical solution, the transmission device includes a connecting belt provided in the belt cavity, the extension shaft and the through axis extend rearwardly, enter the belt cavity, and communicate with the belt cavity. The front and rear side walls are rotatably connected, a power pulley is fixed on the extension shaft and the through shaft, and the two power pulleys are connected by the connection belt.

On the basis of the above technical solution, a support leg is fixed on the bottom surface of the body.

Based on the above technical solution, the diameters of the spray head and the vertical axis are smaller than the diameter of the plastic bottle.

Based on the above technical solution, when the trigger lever drives the rack wedge downward and the rack wedge is reset, it is always aligned with the bottom opening of the plastic bottle.

Based on the above technical solution, the soft bristle brush is made of soft bristles, and the squeeze plate is made of rubber material to have a certain stretchability.

In summary, the present invention has the beneficial effects that the device can clean and flatten plastic bottles after people have finished drinking, thereby completing the automatic preliminary processing of the plastic bottles. Compared with the traditional processing method, the device does not The plastic bottle needs to be processed manually, which saves manpower and material resources. At the same time, the device cleans the plastic bottle, so that it can guarantee the sanitary protection during subsequent reprocessing.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic front structural view of the entire full-section of a plastic beverage bottle cleaning and recycling compression device according to the present invention;

FIG. 2 is a sectional front view of the rear side in FIG. 1 of the present invention;

FIG. 3 is a partially enlarged view of the position A in FIG. 1 of the present invention.

### DETAILED DESCRIPTION OF THE INVENTION

All features disclosed in this specification, or all disclosed methods or steps, other than mutually exclusive features and/or steps, may be combined in any manner.

Any feature disclosed in this specification (including any additional claims, abstract, and drawings), unless specifically stated, may be replaced by other equivalent or similar purpose alternative features. That is, unless specifically stated, each feature is just one example of a series of equivalent or similar features.

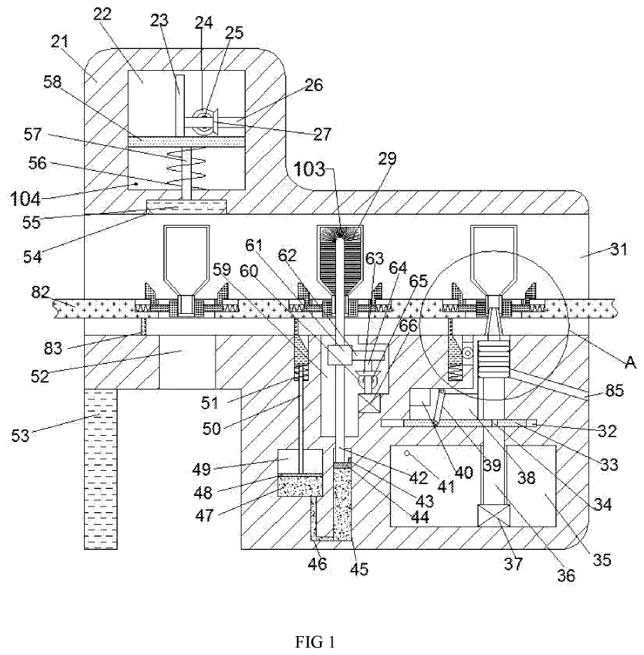

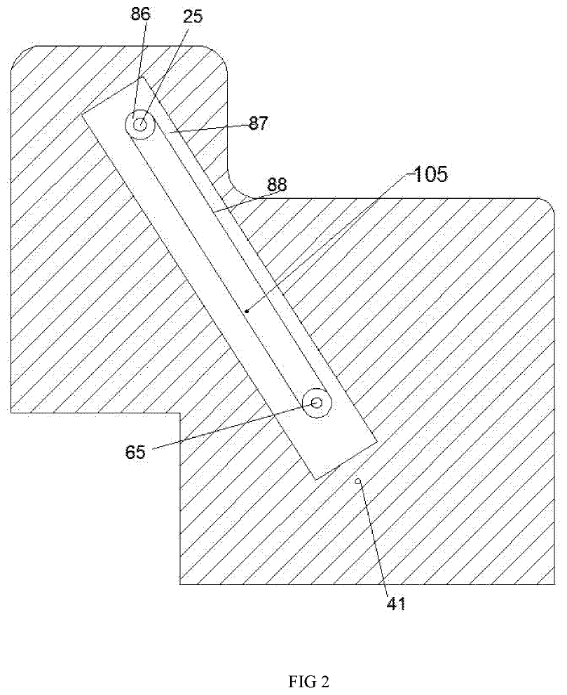

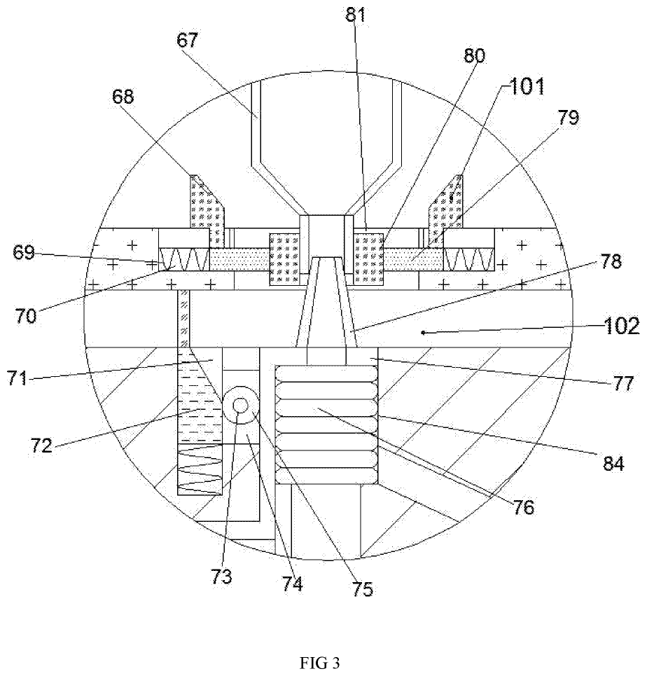

The present invention will be described in detail below with reference to FIGS. 1-3. Among them, for convenience of description, the orientation described below is defined as follows: the up-down, left-right, left-back, and up-down directions described below are consistent with the front-back, left-right, up, down, and down directions of the view direction of FIG. 1, 1 is a front view of the device of the present invention, and the direction shown in FIG. 1 is the same as the front, rear, left, right, and up and down directions of the device of the present invention.

Please refer to FIGS. 1-3. An embodiment of the present invention provides a plastic beverage bottle cleaning, recycling and compression device, which includes a body 21. The body 21 is provided with a working cavity 31, and the working cavity 31 is provided with A moving conveyor belt 82 having a fixing cavity 81 therein. The fixing cavity 81 is provided with a fixing device 101 for fixing a water bottle. The fixing device 101 includes left and right symmetrically arranged on the side wall of the fixing cavity 81. The top chute 70 is slidably connected with a top rod 79. A small spring 69 is connected between the top rod 79 and the top chute 70. The top side of the top rod 79 is fixedly provided. A trapezoidal block 68, a fixing block 80 for clamping the bottle mouth is fixed on one side of the ejection rod 79, a plastic bottle 67 can be fixedly connected to the fixing block 80, and a trigger lever 83 is fixed on the bottom surface of the conveyor belt 82 The bottom wall of the working chamber 31 is provided with a cleaning chamber 84 which is opened downward. A bottom side of the cleaning chamber 84 is provided with a water tank 35. A water outlet pipe 36 is connected between the water tank 35 and the cleaning chamber 84. A water spraying device 102 for cleaning plastic bottles is provided between the water tank 35 and the cleaning cavity 84, and the working cavity The bottom wall of 31 is provided with a power cavity 59. The power cavity 59 is provided with a brush head device 103 for assisting cleaning of plastic bottles. The top wall of the working cavity 31 is provided with an opening cavity 54. A squeezing cavity 22 is provided on the side, and a squeezing device 104 for squeezing a plastic bottle is provided in the squeezing cavity 22. A drop cavity 52 is provided on the bottom wall of the working cavity 31. The rear side is provided with a transmission device 105 for transmitting power to the pressing device 104.

In addition, in one embodiment, the water spraying device 102 includes a drainage pipe 85 provided on the right side wall of the cleaning chamber 84, and the bottom wall of the working chamber 31 is symmetrically provided with a wedge chute 71 with downward openings. The wedge chute 71 is slidably connected with a rack wedge 72 that can abut against the trigger lever 83. The right side wall of the wedge chute 71 is provided with the cleaning chamber 84. A communication shaft 74 is communicated, and a rotation shaft 73 is rotatably connected to the front and rear side walls of the communication cavity 74. A rotation gear 75 meshing with the rack wedge 72 is fixed on the rotation shaft 73, and the cleaning cavity 84 The bottom wall is provided with a switching cavity 38. The right side of the rotary gear 75 is engaged with a chamfered rack 77. The top surface of the chamfered rack 77 is fixed with a nozzle 78. The bottom side of the chamfered rack 77 is fixed. There is a telescopic hose 76, the bottom side of the telescopic hose 76 is in communication with the outlet pipe 36, and the bottom wall of the water tank 35 is fixed with a water pump 37 connected to the outlet pipe 36. The rear side wall is provided with a water injection port 41 opening backward, a bottom surface of the angled rack 77 is hinged with a hinge rod 39, and a bottom wall of the switching cavity 38 is provided through the outlet. A horizontal plate slide groove 32 of the pipe 36, and a bottom plate 33 of the hinge rod 39 is hinged with a horizontal plate 33 slidably connected to the horizontal plate slide groove 32. The horizontal plate 33 is provided with a communication with the water outlet pipe 36 Through hole 34, the rear side wall of the switching cavity 38 is provided with an inlet 40 for adding detergent, so that when the trigger lever 83 pushes the rack wedge 72 on the right side downward, thereby driving the The rotation gear 75 rotates, thereby driving the angled rack 77 and the telescopic hose 76 to move upward, thereby driving the horizontal plate 33 to the right through the hinge rod 39, and the through hole 34 moves the The cleaning agent in the switching cavity 38 is brought to the water outlet pipe 36, and the water pump 37 sprays water in the water tank 35 through the water outlet pipe 36, the through hole 34 and the spray head 78 into the plastic Bottle 67, thereby completing the washing.

In addition, in one embodiment, the brush head device 103 includes a motor 66 fixedly installed on the bottom wall of the power cavity 59. A motor shaft 64 is dynamically connected to the motor 66, and the top side of the motor shaft 64 is fixed. A power gear 62 is provided, and a first bevel gear 63 is fixed on the middle side of the motor shaft 64. A rear shaft 65 is rotatably connected to the rear side wall of the power cavity 59, and a front side of the through shaft 65 is fixed A second bevel gear 60 that can be meshed with the first bevel gear 63 is provided with a hydraulic chute 45 on the bottom side of the power chamber 59, and an oil pipe 46 is provided on the left side wall of the hydraulic chute 45. An oil tank 49 is provided on the top wall of 46, and a long rod 50 slidingly connected to the bottom wall of the left-side wedge chute 71 is slidably connected to the bottom surface of the rack wedge 72 on the left. The lower wall extends through the bottom wall of the wedge chute 71 and enters the oil tank 49, and is slidably connected to the top wall of the oil tank 49. The bottom side of the long rod 50 is fixed to slide with the oil tank 49. The pressure plate 48 is connected to the right side of the hydraulic chute 45, and a limiting block 43 is fixed. A hydraulic slider 44 is slidably connected to the hydraulic chute 45. A hydraulic oil 47 is provided between the pressure slider 44 and the pressure plate 48. A vertical shaft 42 is rotatably connected to the top side of the hydraulic slider 44, and the vertical shaft 42 slides with the top wall of the hydraulic chute 45. The top side of the vertical shaft 42 extends upward through the top wall of the hydraulic chute 45 into the power chamber 59 and is slidably connected to the bottom wall of the power chamber 59. A moving gear 61 that can be engaged with the power gear 62 is fixed on the side, and a soft bristle brush 29 for cleaning the inner wall of the plastic bottle 67 is fixed on the top side of the vertical shaft 42 so that the rack on the left side When the wedge 72 moves downward, the long rod 50 and the pressure plate 48 are moved downward, so that the hydraulic oil 47 is squeezed into the hydraulic chute 45, thereby driving the hydraulic slide The block 44, the vertical shaft 42 and the soft-bristle brush 29 move upward, the moving gear 61 thereby meshes with the power gear 62, and then the motor 66 is turned on, thereby driving the motor shaft 64, the The first bevel gear 63, the power gear 62, the vertical shaft 42 and the soft bristle brush 29 are rotated to complete the cleaning of the bottle.

In addition, in one embodiment, the pressing device 104 includes a horizontal shaft 26 rotatably mounted on the right wall of the pressing cavity 22, and a third bevel gear 27 is fixed on the middle side of the horizontal shaft 26. A cam 23 is fixed on the left side of the horizontal shaft 26, and an extension shaft 25 is rotatably connected to the rear side wall of the extrusion cavity 22. The front side of the extension shaft 25 is fixedly engaged with the third bevel gear 27 In the fourth bevel gear 24, a pushing plate 58 is slidably connected to the pressing cavity 22, and a strong spring 56 is connected between the pushing plate 58 and the 22. A fine side is fixed on the bottom side of the pushing plate 58. A rod 57 that extends downward through the bottom wall of the extrusion cavity 22 and enters the opening cavity 54, and is connected to the bottom wall of the extrusion cavity 22 and the top wall of the opening cavity 54 Sliding connection, the bottom side of the thin rod 57 is fixed with a pressing plate 55 that can abut the trapezoidal block 68, so that when the extension shaft 25 rotates, the fourth bevel gear 24, The third bevel gear 27, the horizontal shaft 26, and the cam 23 rotate, thereby driving the pushing plate 58 to move up and down, and thereby driving the pressing plate 55 through the thin rod 57.

In addition, in one embodiment, a supporting leg 53 for supporting is fixed on the bottom surface of the body 21.

In addition, in one embodiment, the diameter of the spray head 78 and the vertical shaft 42 is smaller than the diameter of the plastic bottle 67.

In addition, in one embodiment, when the trigger lever 83 drives the rack wedge 72 downward and the rack wedge 72 is reset, it is always aligned with the bottom opening of the plastic bottle 67.

In addition, in one embodiment, the soft bristle brush 29 is made of soft hair, which can effectively clean the inner wall of the plastic bottle 67, and the squeeze plate 55 is made of rubber material and has a certain elasticity, which can The pressing plate 55 is prevented from crushing the trapezoid block 68.

When handling plastic bottles of beverages, first remove the motors 66, fix each plastic bottle 67 between the fixing blocks 80, then inject water into the water injection port 41, add detergent to the inlet 40, and then turn on the motor 66 and water pump 37, when the conveyor belt 82 moves to the left, the trigger lever 83 pushes the rack wedge 72 on the right side downward, thereby driving the rotation gear 75 to rotate, thereby driving the angled rack 77 and the telescopic hose 76 upward. Move, so that the horizontal plate 33 is moved to the right by the hinge rod 39. The through hole 34 brings the detergent in the switching cavity 38 to the water outlet pipe 36. The water pump 37 passes the water in the water tank 35 through the water outlet pipe 36, the through hole 34 and The spray head 78 is sprayed into the plastic bottle 67 to complete the cleaning. The trigger lever 83 pushes the left rack wedge 72 downward, thereby driving the long rod 50 and the pressure plate 48 to move downward, thereby squeezing the hydraulic oil 47 into the hydraulic pressure. In the chute 45, the hydraulic slider 44, the vertical shaft 42, and the soft brush 29 are moved upward, the gear 61 is moved to mesh with the power gear 62, and then the motor 66 is turned on to drive the motor shaft 64 and the first bevel gear 63 , The power gear 62, the vertical shaft 42, and the soft bristle brush 29 rotate, thereby completing For cleaning inside the pair of bottles, the penetrating shaft 65 drives the extension shaft 25 through the power pulley 86 and the connecting belt 88, so that when the extension shaft 25 rotates, the fourth bevel gear 24, the third bevel gear 27, and the horizontal shaft 26 are driven. The cam 23 rotates, so that the push plate 58 moves up and down, and the squeeze plate 55 is driven down by the thin rod 57 to flatten the plastic bottle 67, and then the trapezoid block 68 is pressed to the left and right sides to make the plastic bottle 67 is dropped from the fixing cavity 81 into the dropping cavity 52, so that the dropping cavity 52 is discharged.

The beneficial effect of the present invention is that the device can clean and flatten the plastic bottles after people have finished drinking, thereby completing the automatic preliminary processing of the plastic bottles. Compared with the traditional processing method, the device does not require manual processing. The plastic bottle saves manpower and material resources. At the same time, the device will clean the plastic bottle, so that it can guarantee the sanitary protection during subsequent reprocessing.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. A device for cleaning, recycling, and compressing plastic beverage bottles, comprising a body, characterized in that: the body is provided with a working cavity, the working cavity is provided with a moving conveyor belt, and the conveyor belt is provided with a fixed cavity. The fixing cavity is provided with a fixing device for fixing a water bottle;
the fixing device includes a top chute symmetrically disposed on a side wall of the fixing cavity, and a top rod is slidably connected in the top chute, and a small spring is connected between the top rod and the top chute. A trapezoidal block is fixed on the top side of the ejector rod, and a fixing block for gripping the bottle mouth is fixed on one side of the ejector rod. The fixing block can be fixedly connected with a plastic bottle, and the bottom surface of the conveyor belt is fixedly provided. A trigger lever, a bottom wall of the working chamber is provided with a cleaning chamber with an opening downward, a bottom side of the cleaning chamber is provided with a water tank, and a water outlet pipe is connected between the water tank and the cleaning chamber;
a water spraying device for cleaning plastic bottles is provided between the water tank and the cleaning cavity, a power cavity is provided on the bottom wall of the working cavity, and a brush head device is provided in the power cavity to assist in cleaning the plastic bottles. An opening cavity is provided on the top wall of the working cavity, and an extrusion cavity is provided on the top side of the opening cavity. An extrusion device for squeezing a plastic bottle is provided in the extrusion cavity, and a bottom of the working cavity is provided. The wall is provided with a drop cavity, and the rear side of the working cavity is provided with a transmission device for transmitting power to the pressing device.

2. The device for cleaning, recycling, and compressing a plastic beverage bottle according to claim 1, wherein the water spraying device comprises a drainage pipe provided on a right wall of the cleaning chamber, and a bottom wall of the working chamber is symmetrical to the left and right A wedge chute with a downward opening is provided, and a rack wedge that can abut against the trigger lever is slidably connected in the wedge chute, and the right side wall of the wedge chute on the right side is provided with There is a through cavity that communicates with the cleaning cavity. Rotary shafts are rotatably connected to the front and rear side walls of the through cavity. Rotating gears that mesh with the rack wedge are fixed on the rotating shaft. The bottom wall is provided with a switching cavity. The right side of the rotary gear is engaged with a chamfered rack. The top surface of the chamfered rack is fixed with a spray head. The bottom side of the chamfered rack is fixed with a telescopic hose. The bottom side of the telescopic hose is in communication with the outlet pipe, the bottom wall of the water tank is fixedly provided with a water pump connected to the outlet pipe, and the rear side wall of the water tank is provided with a water injection port opening backward, A hinge rod is hinged on the bottom surface of the angled rack, and a bottom wall of the switching cavity is provided to penetrate the water outlet. A horizontal plate chute of a pipe, a bottom plate of the hinge rod is hinged with a horizontal plate slidingly connected to the horizontal plate chute, and a through hole that can communicate with the outlet pipe is provided in the horizontal plate, the switching The rear wall of the cavity is provided with an adding port for adding a cleaning agent.

3. The cleaning, recycling and compression device for a plastic beverage bottle according to claim 1, wherein the brush head device comprises a motor fixedly installed on the bottom wall of the power chamber, and a motor is connected to the motor in power. A power gear is fixed on the top side of the motor shaft, a first bevel gear is fixed on the middle side of the motor shaft, and a through shaft is rotatably connected to the rear side wall of the power chamber. A second bevel gear that can be engaged with the first bevel gear is fixed on the side. A hydraulic chute is provided on the bottom side of the power chamber. A left side wall of the hydraulic chute is provided with an oil pipe. An oil tank is provided on the wall, and a long rod slidingly connected to the bottom wall of the wedge chute on the left side is slidably connected to the bottom surface of the rack wedge on the left side, and the long rod extends downward through the wedge slide. The bottom wall of the tank enters into the fuel tank and is slidably connected to the top wall of the fuel tank. A pressure plate slidingly connected to the fuel tank is fixed to the bottom side of the long rod, and the right side of the hydraulic chute is fixed. A limiting block is fixed on the surface, and a hydraulic slider is slidingly connected to the hydraulic chute. A hydraulic oil is provided between the pressure slider and the pressure plate. A vertical shaft is rotatably connected to the top side of the hydraulic slider, and the vertical shaft is slidingly connected to the top wall of the hydraulic chute. The top side extends upward through the top wall of the hydraulic chute and enters the power chamber and is slidably connected to the bottom wall of the power chamber. The middle side of the vertical shaft is fixed with a movement that can mesh with the power gear. A soft brush is fixed on the top side of the vertical shaft for cleaning the inner wall of the plastic bottle.

4. The device for cleaning, recycling, and compressing a plastic beverage bottle according to claim 1, wherein the extrusion device includes a horizontal axis that is rotatably installed on the right wall of the extrusion cavity, A third bevel gear is fixed on the middle side, a cam is fixed on the left side of the horizontal axis, and an extension shaft is rotatably connected to the rear side wall of the extrusion cavity. A fourth bevel gear meshed with a third bevel gear, a pushing plate is slidably connected in the squeeze cavity, a strong spring is connected between the pushing plate and the thin plate, and a thin rod is fixed on the bottom side of the pushing plate The thin rod extends downward through the bottom wall of the extrusion cavity into the opening cavity, and is slidably connected to the bottom wall of the extrusion cavity and the top wall of the opening cavity. The bottom side is fixedly provided with an extruding plate which can abut against the trapezoidal block.

5. The device for cleaning, recycling, and compressing a plastic beverage bottle according to claim 1, wherein the transmission device comprises a connecting belt provided in the belt cavity, the extension shaft and the through-axis It extends rearwardly, enters into the belt cavity, and is rotationally connected to the front and rear side walls of the belt cavity. A power pulley is fixed on the extension shaft and the through shaft. Said connection belt connection.

6. The device for cleaning, recycling, and compressing a plastic beverage bottle according to claim 1, characterized in that: a support leg is fixed on the bottom surface of the body.

7. The device for cleaning, recycling, and compressing a plastic beverage bottle according to claim 3, wherein the diameter of the spray head and the vertical axis is smaller than the diameter of the plastic bottle.

8. The device for cleaning, recycling, and compressing a plastic beverage bottle according to claim 3, characterized in that: when the trigger lever drives the rack wedge downward and the rack wedge is reset, it is always Align the bottom opening of the plastic bottle.

9. The device for cleaning, recycling and compressing a plastic beverage bottle according to claim 4, wherein the soft bristle brush is made of soft bristles, and the squeeze plate is made of rubber material and has a certain stretchability 10.
